(19) United States
(12) Patent Application Publication
(10) Pub. No.: US 2019/0169004 A1
(43) Pub. Date: Jun. 6, 2019

(54) Off-Road Specialized Jack

(71) Applicant: Austin International Manufacturing, Inc., Torrance, CA (US)

(72) Inventors: Austin Su, Torrance, CA (US); Charles Foreman, Torrance, CA (US); Benson Su, Torrance, CA (US)

(21) Appl. No.: 15/831,322

(22) Filed: Dec. 4, 2017

(51) Int. Cl. B66F 5/00; B60C 7/00

(52) U.S. Cl. CPC B66F 5/00; B60C 2200/14; B60C 7/00

(57) ABSTRACT

An off-road specialized jack having features making it more able to perform its function in off-road environments. Jacks of the inventive subject matter can include a skid plate, large diameter, non-pneumatic wheels, and, in some embodiments, a lift extender to facilitate lifting high-clearance objects or vehicles. The lift extender can be removably coupled with the jack, and its height can be adjusted according to a user's needs.

### FIELD OF THE INVENTION

The field of the invention is off-road specialized equipment.

### BACKGROUND

The background description includes information that may be useful in understanding the present invention. It is not an admission that any of the information provided in this application is prior art or relevant to the presently claimed invention, or that any publication specifically or implicitly referenced is prior art.

Off-road wheeling is a pastime enjoyed by many hobbyists and recreational enthusiasts. Many vehicles used for off-road wheeling are assembled as passion projects, and they often incorporate after-market parts and products to improve the off-road capability of the vehicles. Whether using after-market parts and products or not, though, off-road vehicles are prone to either break down or breakages that require the vehicle to be jacked up to accomplish repair in the field.

Efforts have been made in the past to create off-road specialized jacks, but those efforts fall short. For example, some have attempted to give hydraulic floor jacks a skid plate that creates a larger surface area on the bottom of a jack, thereby obviating the need for the small wheels and casters that are included with hydraulic floor jacks. But this fails to appreciate that it can be advantageous to still include usable wheels.

In another example, hydraulic floor jacks have been fitted with larger pneumatic wheels to improve rolling over rough or soft terrain. But pneumatic wheels are prone to going flat or popping due to the large forces of the weight of a vehicle that bear down on the wheels of a jack.

Typical floor jacks are also generally not capable of lifting a high-clearance vehicle, leaving open a need for a floor jack that takes advantages of technological improvements that enable high-clearance vehicle lifting that is needed by many off-road vehicles.

Thus, there is still a need in the art for an off-road specialized jack.

### SUMMARY OF THE INVENTION

The present invention provides apparatuses, systems, and methods of off-road specialized jacks. In one aspect of the inventive subject matter, an off-road specialized jack is contemplated. The off-road specialized jack includes: a frame; a first axle and a second axle, both coupled with the frame; a lifting mechanism coupled with the frame, where the lifting mechanism having an upper surface and a coupling feature, the coupling feature comprising at least two inward protrusions positioned above the upper surface; a skid plate disposed on an underside of the frame, the skid plate sized and dimensioned to reduce sinking into soft terrain; a first set of wheels coupled with the first axle, wherein the first set of wheels are sized and dimensioned to improve their ability to roll over soft terrain; and a second set of wheels coupled with the second axle, wherein the second set of wheels are sized and dimensioned to improve their ability to roll over soft terrain.

In some embodiments, the first set of wheels have a larger diameter than the second set of wheels. In some embodiments, the skid plate includes a textured surface to resist sliding.

In another aspect of the inventive subject matter, an off-road specialized jack system is contemplated. It includes: (1) a jack having: a frame; a lifting mechanism coupled with the frame where the lifting mechanism has an upper surface and a coupling feature, the coupling feature including at least two inward protrusions positioned above the upper surface; a skid plate disposed on an underside of the frame, the skid plate sized and dimensioned to reduce sinking into soft terrain; and (2) a lifting extension having a second coupling feature on a bottom surface, the second coupling feature having at least two outward protrusions disposed on an end of the lifting extension, wherein the at least two outward protrusions are sized and dimensioned to fit between the upper surface of the lifting mechanism and the at least two inward protrusions of the coupling feature.

In some embodiments, the lifting extension has a circular cross section such that a rotation can cause the at least two outward protrusions to fit between the upper surface of the lifting mechanism and the at least two inward protrusions. In other embodiments, the lifting extension has a rectangular cross section such that a translational movement can cause the at least two outward protrusions to fit between the upper surface of the lifting mechanism and the at least two inward protrusions.

In some embodiments, the jack additionally includes: a first axle and a second axle, both coupled with the frame; a first set of wheels coupled with the first axle, wherein the first set of wheels are sized and dimensioned to improve their ability to roll over soft terrain; and a second set of wheels coupled with the second axle, wherein the second set of wheels are sized and dimensioned to improve their ability to roll over soft terrain.

In some embodiments, the first set of wheels have a larger diameter than the second set of wheels, and the skid plate can optionally include a textured surface to resist sliding during use.

It is contemplated that the lifting extension can also include: a first component and a second component, the first component being sized and dimensioned to fit within the second component, where the first component includes a first hole disposed on a side of the first component and wherein the second component comprises a second hole disposed on a side of the second component; and a pin sized and dimensioned to pass through the first hole and through the second hole to hold the first component and the second component in static positions relative to each other.

In another aspect of the inventive subject matter, another off-road specialized jack is contemplated. It includes: a frame; a lifting mechanism coupled with the frame, where the lifting mechanism has an upper surface and a coupling feature, the coupling feature having at least two inward protrusions positioned above the upper surface; and a skid plate disposed on an underside of the frame, the skid plate sized and dimensioned to reduce sinking into soft terrain.

In some embodiments, the jack additionally includes: a first axle and a second axle, both coupled with the frame; a first set of wheels coupled with the first axle, where the first set of wheels are sized and dimensioned to improve their ability to roll over soft terrain; and a second set of wheels coupled with the second axle, where the second set of wheels are sized and dimensioned to improve their ability to roll over soft terrain.

In some embodiments, the lifting extension has a circular cross section such that a rotation can cause the at least two outward protrusions to fit between the upper surface of the lifting mechanism and the at least two inward protrusions.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a side view of a jack.

FIG. 2 is a top view of a jack.

FIG. 3 is a bottom, perspective view of a jack.

FIG. 4 shows an axle and lifting component of a jack.

FIG. 5 shows a multi-piece lift extender.

FIG. 6 shows the coupling features of a lift extender and a lifting component.

FIG. 7 shows a lift extender coupled with a lifting component.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Off-road jacks of the inventive subject matter (which will be referred to as a “jack” or “jacks” in this application) include a frame having a skid plate on the bottom, solid, non-pneumatic wheels, a lifting component (e.g., the component of the jack that makes contact with the vehicle or thing being lifted by the jack), and, in some embodiments, a lifting extender to improve the off-road jack's ability to lift high clearance vehicles.

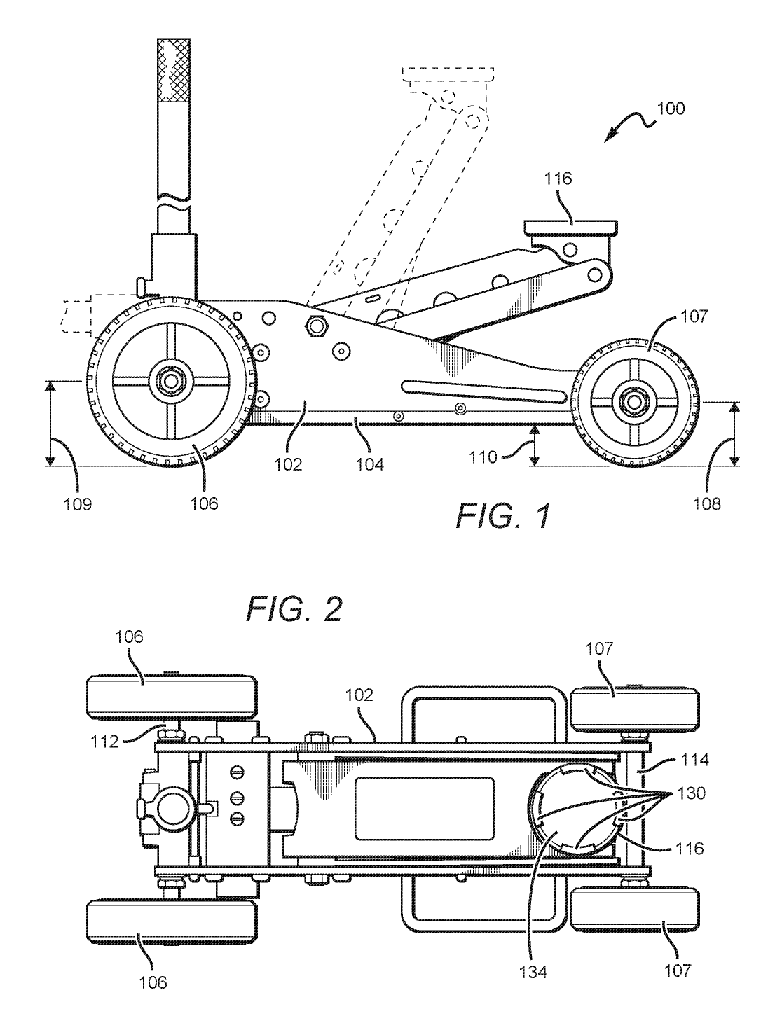

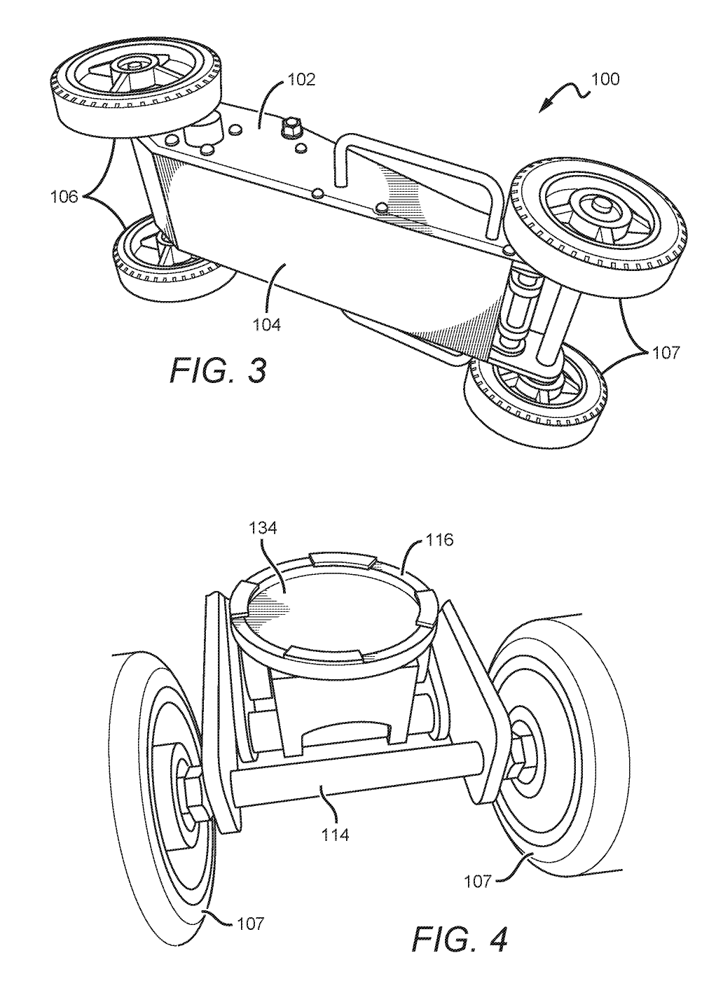

As shown in best FIGS. 1 & 2, the frame 102 of a jack 100 is constructed to give the jack 100 stability and strength while lifting heavy objects such as cars. Ordinary floor jacks rely on small, hard wheels or casters to roll along a hard surface (e.g., concrete or asphalt). As seen in FIG. 3, jacks of the inventive subject matter include a skid plate 104 that is coupled to the frame 102 on the bottom of the jack 100. It is advantageous to include a skid plate 104 on the bottom of the frame 102 because in the course of, for example, off-road use, the jack 100 may need to be used on soft, rough, or uneven terrain, and the skid plate 104 can prevent the jack 100 from sinking into, or resting unevenly on, that terrain. The skid plate 104 helps the jack 100 to function properly regardless of the surface that it is placed on.

As mentioned above, skid plates of the inventive subject matter provide a larger surface area on the bottom of the jack 100 that can be used to support the weight of the jack 100 (and the weight of whatever the jack is lifting). For example, if a jack is used in soft terrain where it could sink into the ground, rendering the jack unable to function as intended (e.g., causing it to tilt in an undesirable way), the skid plate on the bottom helps to prevent sinking by giving a large surface area for the weight of the jack plus payload to press into. This also helps the jack to remain level so the jack can operate as intended by pressing straight up.

It is contemplated that skid plates of the inventive subject matter are substantially flat and fit on the bottom of a jack's frame such that the skid plate is substantially parallel (e.g., within 10 degrees along any axis) to an imaginary plane passing through the bottoms of at least three wheels of the jack. As shown in FIG. 1, the skid plate 104 is parallel to a plane passing through at least three of the jack's 100 wheels. In some embodiments, the skid plate 104 can have a textured surface to reduce sliding of the jack 100 while in operation.

FIGS. 1-4 show wheels 106 & 107 of the inventive subject matter. Wheels 106 & 107 have several features that improve their functionality in the context of off-road and rough-terrain use. For example, wheels 106 & 107 are non-pneumatic. Wheels of the inventive subject matter can be hard plastic, rubber, metal, or other suitable materials (e.g., a material that is hard or tough enough to withstand lifting on off-road terrain). Pneumatic wheels are not ideal for off-road specialized use due to, among other risks, an increased risk of puncture or deflation during operation.

It is contemplated that the jack's wheels 106 & 107 have a larger diameter than would be required of wheels that are implemented on ordinary jacks for use on hard surfaces (e.g., a garage floor). As shown in FIG. 1, the radii 108 & 109 of the wheels 106 & 107 are preferably larger than the elevation 110 of the skid plate 104 off the ground when the jack 100 is placed on level ground. Larger diameter wheels help the jack 100 roll over uneven terrain, and low clearance between the skid plate (elevation 110) and the ground make sure that, even in soft terrain, the jack 100 does not sink too far before the skid plate 104 contacts the ground giving the jack 100 something to press against to lift a vehicle (or other object).

It is contemplated that the radius 108, 109 of one or more of the wheels 106 & 107 can be 1.25-3, 3-4, 4-5, or 5-6 times as large as the height of the skid plate above ground 110 when a jack is placed on a level surface (e.g., a distance between the ground when a jack is placed on a level surface and the skid plate on the bottom of the jack, as measured by a line drawn normal to the ground and drawn from a point on the ground to a point on the skid plate near the relevant wheel). Wheels having larger radii than ordinary jacks are better able to roll over rough or soft terrain—an advantage in off-road situations.

Wheels of the inventive subject matter come in pairs 106 & 107. Each pair of wheels 106 & 107 can have different radii from the other pair. Each pair of wheels is coupled to each other and to the frame by a solid axle 112 & 114. This is different from most floor jacks, which include fixed wheels on one end and casters on the other. But jacks of the inventive subject matter include solid axles 112 & 114 for both sets of wheels 106 & 107. By having the solid axle 112 & 114 for each set of wheels pass through, or couple with, the frame 102 at a location above the skid plate 104, the skid plate 104 can be low to the ground (e.g., 0.25-0.5″, 0.5-1″, 1-1.5″, 1.5-2″ above the ground, as measured by a line drawn normal to a flat ground surface that the jack is resting on drawn from a point on the ground to a point on the skid plate near the relevant wheel) despite a wheel radius 108 & 109 that is larger than the distance 110 between the skid plate and the ground. This keeps the skid 104 of the jack 100 low to the ground to improve stability and the effectiveness of the skid plate 104 when the jack 100 is in use and relying on the skid plate 104 for stability.

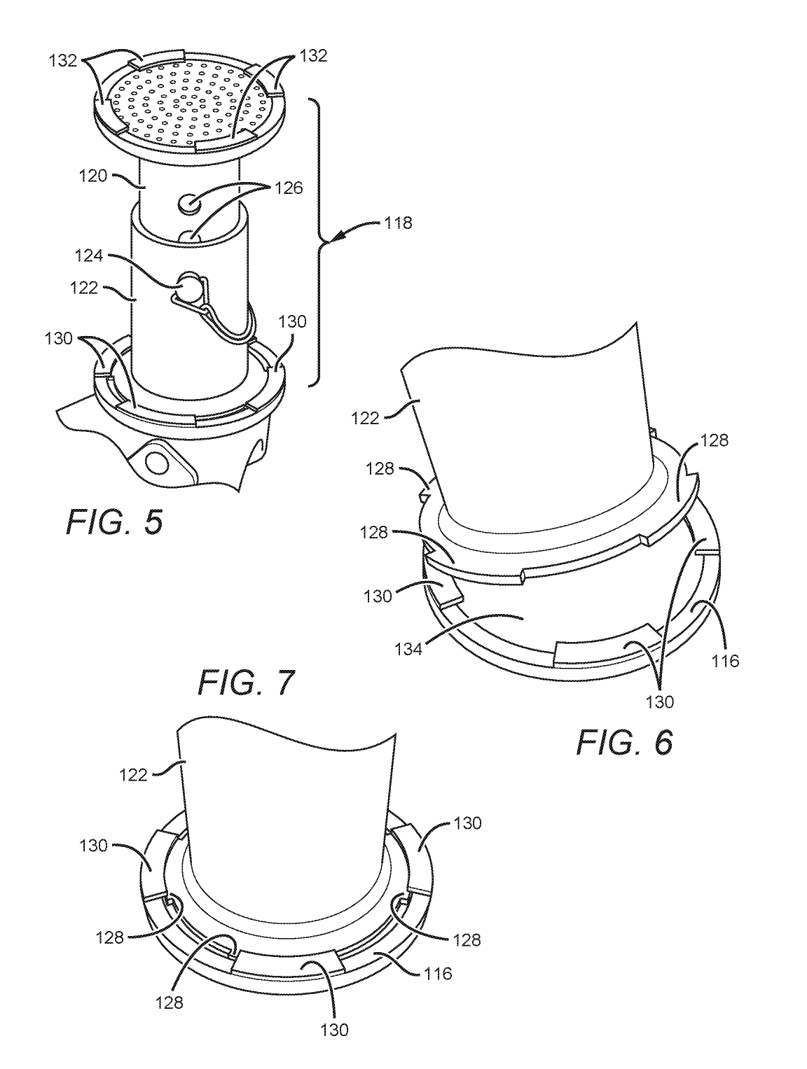

FIGS. 5-7 show a lift extender 118, which couples with the lifting component 116 of a jack 100, which is shown in FIG. 4. (e.g., the component of a jack where the jack typically contacts the vehicle or object to be lifted). It is contemplated that a lift extender 118 of the inventive subject matter can be a single component, or it can be made up of several components that work together for additional functionality. A multi-piece lift extender 118 having a top piece 120 and a bottom piece 122 is shown in FIG. 5. A lift extender 118 is helpful for lifting vehicles having high ground clearance, where ordinary jacks would be ineffective.

The lift extender 118 shown in FIGS. 5-7 is a multi-component embodiment, including at least a top piece 120 and a bottom piece 122. The bottom piece 122 is made so that the top piece 120 can be at least partially disposed within the bottom piece 122 (e.g., in a telescoping manner). The top piece and bottom piece can also be reversed from what is described above: e.g., the bottom piece can be at least partially disposed within the top piece.

The bottom piece 122 and top piece 120 of the lift extender 118 can be held stationary relative to one another by a coupling mechanism. As shown in FIG. 5, the coupling mechanism can be a pin 124 that can pass through holes 126 on both the top piece 120 and the bottom piece 122. The top piece 120 and bottom piece 122 can both include several holes 126 to facilitate adjusting the effective length of the lift extender 118.

It is contemplated that the lift extender 118 can add 3-6″, 6-9″, 9-12″, 12-15″, 15-18″, 18-21″, or 21-24″ of height to jack's lifting ability. In multi-part lift extender embodiments, the top piece 120 and bottom piece 122 of the lift extender 118 can be coupled together via holes 126 on their sides such that the effective height can be adjusted in increments of 0.5-2″ (preferably around 1″). This can be accomplished via spacing of the holes 126 on each of the bottom piece 122 and top piece 120. In some embodiments, only the top piece 120 has a plurality of holes, while in other embodiments, only the bottom piece 122 has a plurality of holes. The top piece 120 and the bottom piece 122 can be the same length or different lengths. For example, it can be advantageous to have a longer bottom piece 122 (e.g., the piece that couples with the jack's lifting component) to improve strength and stability of the lift extender 118.

A variety of cross sections for the lift extender 118 are contemplated (e.g., rounded, circular, rectangular). In some single-piece embodiments, the lift extender 118 can be a solid piece of material (e.g., a solid piece of aluminum, a metal alloy, a composite material) having now interior space. This can improve strength when a particularly heavy object must be lifted. In other embodiments (e.g., both single-piece and multi-piece), the components of the lifting mechanism can be shells with open or closed ends (e.g., having a hollow interior space).

Lift extenders of the inventive subject matter include a coupling feature on at least one end (e.g., comprising outward protrusions 128), but in some embodiments, there can be coupling features on both ends (e.g., outward protrusions 128 on one end and inward protrusions 132 on the other end, as shown in FIG. 5). The outward protrusions 128 on the lift extender 118 facilitates coupling the lift extender 118 with the lifting component 116 of the jack, where the lifting component 116 on the jack can also include a reciprocal coupling feature (e.g., inward protrusions 130).

In jacks of the inventive subject matter, the lifting component 116 has a top surface 134 (e.g., the surface of the lifting component 116 that can contact a vehicle to lift the vehicle up). When additional lifting capability is necessary (e.g., when a high-clearance vehicle need to be lifted), the lifting component 116 includes a coupling feature comprising several (e.g., two or more) inward protrusions 130 that function in cooperation with the top surface 134 of the lifting component 116. As mentioned, the coupling feature of the lifting component 116 includes protrusions 130 that are directed inward toward a center of the top surface 134 of the lifting component 116, as shown in FIG. 6. The inward protrusions 130 create lips (e.g., two or more) that extend over the top surface 134 of the lifting component 116.

The lift extender 118 similarly includes a coupling feature on one end. The coupling feature of the lift extender 118 includes protrusions 128 that are directed outward from the lift extender 118 as shown in FIG. 6. The outward protrusions 128 of the coupling feature on the lift extender 118 are sized and dimensioned to fit between the inward protrusions 130 of the lifting component's coupling feature and the top surface 134 of the lifting component 116.

In some embodiments, as shown in FIGS. 5-7, the lift extender's outward protrusions 128 are configured to twist into place in cooperation with the lifting component's inward protrusions 130. For example, the outward protrusions 128 can fit in between the inward protrusions 130 so that the bottom surface of the lift extender 118 can rest against the top surface 134 of the lifting component 116. Once in position on the top surface 134 of the lifting component 116, the lift extender 118 can be rotated so that its outward protrusions 128 rest beneath the inward protrusions 130 of the lifting component 116 as seen in FIG. 7. This holds the lift extender 118 stationary relative to the lifting component 116, facilitating lifts of objects or vehicles with lift points that are too high up for an ordinary floor jack to reach.

In some embodiments, the lift extender's coupling feature couples with the lifting component's coupling feature by sliding into place (as opposed to rotating into place). By sliding the lift extender into place, the outward protrusions of the lift extender's coupling feature can be positioned beneath the inward protrusions of the lifting component's coupling feature. In these embodiments, the cross section of the lift extender and the lifting component can be rectangular to facilitate a translation into place as opposed to a rotation.

It is additionally contemplated that the top of a lift extender 118 can include another coupling feature similar to the coupling feature of the lifting component 116 on the jack itself. This can enable multiple lift extenders to couple together to increase effective lifting height of a jack. As shown in FIG. 5, one end of a lift extender 118 can include inward protrusions 132 that can accommodate the outward protrusions 128 of a separate lift extender.

Thus, specific compositions and methods of a specialized off-road jack have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. An off-road specialized jack, comprising:
a frame;
a first axle and a second axle, both coupled with the frame;
a lifting mechanism coupled with the frame;
the lifting mechanism having an upper surface and a coupling feature, the coupling feature comprising at least two inward protrusions positioned above the upper surface;
a skid plate disposed on an underside of the frame, the skid plate configured to reduce sinking into soft terrain;
a first set of wheels coupled with the first axle, wherein the first set of wheels are configured to improve their ability to roll over soft terrain; and
a second set of wheels coupled with the second axle, wherein the second set of wheels are configured to improve their ability to roll over soft terrain.

2. The off-road specialized jack of claim 1, wherein the first set of wheels have a larger diameter than the second set of wheels.

3. (canceled)

4. An off-road specialized jack system, comprising:
a jack comprising:
a frame;
a lifting mechanism coupled with the frame;
the lifting mechanism having an upper surface and a coupling feature, the coupling feature comprising at least two inward protrusions positioned above the upper surface;
a skid plate disposed on an underside of the frame, the skid plate configured to reduce sinking into soft terrain;
a lifting extension comprising a second coupling feature on a bottom surface, the second coupling feature having at least two outward protrusions disposed on an end of the lifting extension, wherein the at least two outward protrusions are configured to fit between the upper surface of the lifting mechanism and the at least two inward protrusions of the coupling feature.

5. The system of claim 4, wherein the lifting extension has a circular cross section such that a rotation can cause the at least two outward protrusions to fit between the upper surface of the lifting mechanism and the at least two inward protrusions.

6. The system of claim 4, wherein the jack further comprises:
a first axle and a second axle, both coupled with the frame;
a first set of wheels coupled with the first axle, wherein the first set of wheels are configured to improve their ability to roll over soft terrain; and
a second set of wheels coupled with the second axle, wherein the second set of wheels are configured to improve their ability to roll over soft terrain.

7. The system of claim 6, wherein the first set of wheels have a larger diameter than the second set of wheels.

8. (canceled)

9. (canceled)

10. The system of claim 4, wherein the lifting extension further comprises:
a first component and a second component, the first component being configured to fit within the second component;
wherein the first component comprises a first hole disposed on a side of the first component and wherein the second component comprises a second hole disposed on a side of the second component; and
a pin configured to pass through the first hole and through the second hole to hold the first component and the second component in static positions relative to each other.

11. An off-road specialized jack, comprising:
a frame;
a lifting mechanism coupled with the frame;
the lifting mechanism having an upper surface and a coupling feature, the coupling feature comprising at least two inward protrusions positioned above the upper surface; and
a skid plate disposed on an underside of the frame, the skid plate configured to reduce sinking into soft terrain.

12. The off-road specialized jack of claim 11, wherein the jack further comprises:
a first axle and a second axle, both coupled with the frame;
a first set of wheels coupled with the first axle, wherein the first set of wheels are configured to improve their ability to roll over soft terrain; and
a second set of wheels coupled with the second axle, wherein the second set of wheels are configured to improve their ability to roll over soft terrain.

13. The off-road specialized jack of claim 12, wherein the lifting extension has a circular cross section such that a rotation can cause the at least two outward protrusions to fit between the upper surface of the lifting mechanism and the at least two inward protrusions.

14. (canceled)
